(19) United States
(12) Patent Application Publication
(10) Pub. No.: US 2011/0040437 A1
(43) Pub. Date: Feb. 17, 2011

(54) Robot Confinement Method

(76) Inventor: James Lynch, Georgetown, MA (US)

Correspondence Address: James Lynch, 6 Fazio Farm Road, Georgetown, MA, 01833, US

(21) Appl. No.: 12/832,060

(22) Filed: Jul. 7, 2010

Related U.S. Application Data
(60) Provisional application No. 61/272,108, filed on Aug. 17, 2009.

(51) Int. Cl. G05D 1/00; G02B 27/00

(52) U.S. Cl. 701/23; 359/614; 901/1

(57) ABSTRACT

A confinement device for a mobile robot. A confinement device for a mobile robot preventing the robot from entering a space or region in which the user would like to safeguard or to keep the robot bound within a given space eliminating travel into sensitive or dangerous areas. The confinement device comprises materials used to absorb

### BACKGROUND OF THE INVENTION

1. Field of the Invention

Confinement of a Mobile Robot.

Specifically, a device to confine or restrict a mobile robot vacuum cleaner from a user defined area using the cliff or ledge detection sensors in the mobile robot.

2. Brief Description of the Invention

The containment system disclosed is composed of a light source capable of emanating light energy, a light energy receiver capable of receiving the emitted light energy and a light energy inhibitor capable of interacting with the emitted light energy and encompasses the confinement of robotic vacuum cleaners.

Robot vacuum cleaners by design are intended to be an aid in keeping a home clean by autonomously cleaning different floor surfaces throughout the home. Typical floor surfaces may be carpet, wood, linoleum, tile or other common materials used in today's home construction. Most all robot vacuum cleaners have safeguards to prevent them from endangering a human, the contents of the home or themselves. Perhaps the most important safeguard of all is the ability to detect a stair or ledge that would cause the robot to tumble down a set of stairs. Not only would this be a serious situation if a child or even a adult were near but it would also cause considerable damage to the home and would most likely render the vacuum cleaning robot useless. It is therefore this most obvious condition that warrants most all vacuum cleaner robot manufacturers to install a plurity of floor detection sensors that will stop the robot from proceeding if the determination is made that the floor just ahead is no longer detected. Several methods exist for the robot vacuum cleaners to employ a floor detection scheme with some common methods being the transmission and reflection of infrared light, mechanical switches and tilt sensor devices. Due to limitations concerning price, reliability and ease of manufacture, the utmost common method employed by vacuum cleaner robot manufacturers is the transmission and reflection of infrared light method.

Using infrared transmitting and receiving electronics housed within the robot vacuum cleaner, the robot vacuum cleaner produces infrared light at the floor surface just ahead of the path of the robot. The floor detection scheme is based on the principle that if the transmitted infrared light generated were to strike the floor at the correct focal distance, a portion of the infrared light would be reflected back to the robot chassis where it would be detected by the infrared receiver electronics. The reception of infrared light back to the vacuum cleaning robot would then signify that the floor has been detected and it is safe to proceed along its current path.

To safeguard against false detection, a scheme of synchronous detection may or may not be used in which light measurements are first taken with no transmitted infrared light to form a baseline measurement. Once a baseline has been established, light measurements are again taken with emission of transmitted infrared light and are compared to a baseline threshold to cancel out any stray infrared light caused by the environment. Weather using synchronous detection or not, the lack of reflected light back to the vacuum cleaning robot when it is transmitting infrared light is cause for alarm due to the fact that it is likely that there is no floor surface just ahead of the path of the robot. With no floor detected, it is then assumed that a step or drop lies ahead and the robot should take immediate action such as to back up and turn away as to avoid falling down the set of stairs or ledge.

Aside from the safety requirement described above, another desirable feature of a robot vacuum cleaner system is the ability of the user to be able to confine a vacuum cleaner robot to a particular space or to avoid it entering a given area. Methods do exist to aid in this confinement such as the Virtual Wall device produced by the iRobot Corporation which emits an infrared beam several inches above the floor surface which is then detected by the robot vacuum cleaning robot, causing it to turn away. Several problems exist however with this method of confinement which will become apparent with the following description.

The first problem associated with the confinement system of the present art is that light only travels in a straight line which forces the boundary area to also be defined by a straight line which tends to leave many irregular shaped areas unable to be protected. Of course many confinement devices could be used together to form a piecewise linear circle for example to eliminate the entanglement of the vacuum cleaning robot in the Christmas tree skirt, but the reflective and absorption of infrared light on different materials, textures and colors would make it nearly impossible to construct such a boundary.

Secondly it is also of major concern in that it is the requirement that an additional infrared receiver element be mounted on the topmost portion of the robot vacuum cleaner for the purpose of receiving the infrared barrier signal. This added receiver element and associated electronics adds significant cost to the manufacture of the robotic cleaning device and also adds constraints to the design of the robot enclosure itself.

Thirdly, electrical power in the transmitting device must be periodically replaced, causing increased user costs and undesired landfill waste. Lastly, it is a tedious task for the user to remember to set these confinement devices to the on position each and every time the robot vacuum cleaner is used and in the case of confinement devices that automatically turn themselves on, can be even more of a significant power drain and cause for even greater battery consumption.

It is therefore the intent of the present invention to produce an infinitely variable, battery free, low profile robot boundary and confinement system that utilizes the floor detection system inherent in the robot to fool the robot in determining that the floor is no longer present, causing the robot to turn away from the immediate area as defined by the placement of such devices.

### SUMMARY OF THE INVENTION

The present invention embodies a confinement device that may be placed in an arbitrary shape or pattern which utilizes the floor detection circuitry within the robot as means for confinement or prohibiting access, therefore producing a confinement system.

A typical containment system is composed of a light source capable of emanating light energy, a light energy receiver capable of receiving the emitted light energy and a light energy inhibitor capable of interacting with the emitted light energy. In a typical application, both the light energy transmitter and light energy receiver are located on the mobile robot device and one example of such devices are described above as the cliff detection infrared transmitter and infrared receiver respectively. The light energy inhibitor would be placed in the environment in the path of the vacuum cleaning robot and would cause a series of instructions to be performed by the mobile robot once the receiving light system detected a decrease in received light energy interacted on by the light inhibitor that was below a received light level threshold.

The embodiment includes a material with specific features which work together to successfully absorb light and act as the light inhibitor. It is a first requirement of the material to have a surface texture known to have low reflectivity. Secondly, the invention also presents a surface that allows infrared light from the vacuum cleaning robot to enter the structure of the material and to reflect internally in directions not parallel to the transmitted light therefore minimizing the amount of light energy to successfully be reflected back. Lastly, it is also a requirement of the present invention that the base material used to bind the surface texture elements also absorb any infrared light.

The invention has been developed utilizing a material that resembles black carpet, with the features described above. The surface texture is a fibrous surface with a typical depth of 4 mm constructed of low gloss material such as polypropylene or any other suitable low gloss fiber that exhibits these properties. The base material for bounding the fibers is also polypropylene material constructed in a web like structure used to hold all the fiber intact yet still act as an infrared absorbing element.

In its preferred embodiment, the confinement devices are manufactured in strips that are approximately twenty inches long and two inches wide but may also be formed in the shape of a rectangular mat with typical dimensions of fifteen inches by nineteen inches or forty-five inches by nineteen inches respectively. The confinement devices are placed in the path of the mobile robot such that the confinement device is detected when the outer parameter of the mobile robot is in proximity to device. The length of the device is arbitrary however the width of the device does need to be proportional to the speed of the vacuum cleaning robot and the response time of the floor detection system. A typical minimum width for a confinement device of this type with a vacuum cleaning robot traveling at a forward speed of one foot per second is one and one half inches to two inches respectively. To aid in stability of the confinement device, it may also be desired to have the edges of the device tapered to provide a smooth transition from the floor to the top surface of the device. A user may use two segments to safeguard wires next to a computer or may use several segments to form a guard around a tree skirt around a Christmas tree at holiday time. Segments may be joined by hook and loop fasteners, adhesive tape, magnetic attraction, string or interlocking shapes. In low friction applications, robot confinement devices may have a form of adhesion on the bottom to provide some stability such that the contact of the vacuum cleaning robot does not reposition the material over a prolonged period of time.

It is obvious to those skilled in the art that the robot confinement device described above may also be constructed in different shapes and sizes for protecting sensitive items such as plants, entanglement with shoes with long shoe laces, valuables or a child's play mat on the floor and fabricated with alternative materials to enhance the look of the devices without upsetting the infrared light absorbing properties described above. It is also of great importance to note that the confinement system described above may be used with a single light inhibiting device used to safeguard a particular problem area of the cleaning space or may be use with an infinite number of inhibiting devices to safeguard a large factory or workspace. It is also important to note that the light inhibiting properties of the invention may be fabricated into the flooring material itself to provide a clean or stylish look that is flush to the surface. The inhibiting device also may provide a more systematic method of cleaning by causing the mobile robot to react in a manner that in turn guides the mobile robot in a predetermined path rather than in a random manner.

### BRIEF DESCRIPTION OF THE DRAWINGS

A preferred embodiment of the invention, illustrative of the best mode in which applicant has contemplated applying the principles of the invention, is set forth in the following description and drawings and will be particularly and distinctly pointed out and set forth in the claims of the formal application.

FIG. 1 is a top view photo of a typical Robot Confinement Device.

FIG. 2 is a bottom view photo of a typical Robot Confinement Device

FIG. 3 is a side view of a typical Robot Confinement Device.

FIG. 4 is a robot confinement device protecting a plant.

FIG. 5 is a photo of a Robot Confinement Device in the form of a mat protecting a child's toy.

FIG. 6 is a photo of a Robot Confinement Device protecting wires in a curved pattern.

FIG. 7 is a photo of a Robot Confinement Device preventing the entrapment of a vacuum cleaning robot under a low couch.

FIG. 8 is a photo of a robot confinement device of various shapes and sizes.

FIG. 9 is a photo of a robot confinement device protecting entanglement of shoes and shoe laces.

FIG. 10 is a photo of a robot confinement device protecting a child's toy.

FIG. 11 is a photo of robot confinement device protecting pet bowls.

### DESCRIPTION OF THE PREFERRED EMBODIMENT

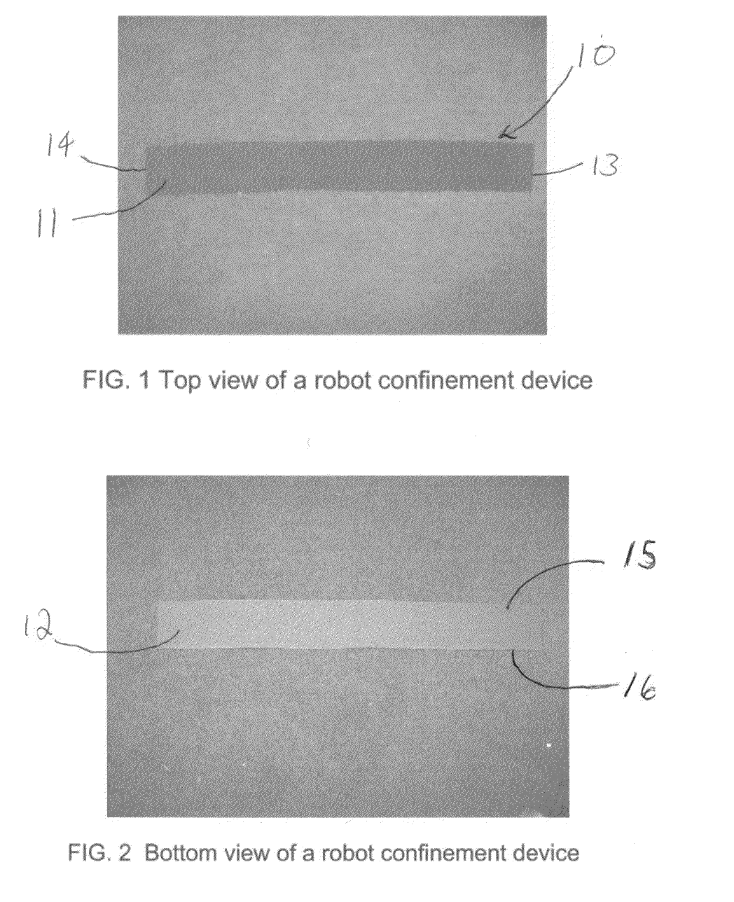

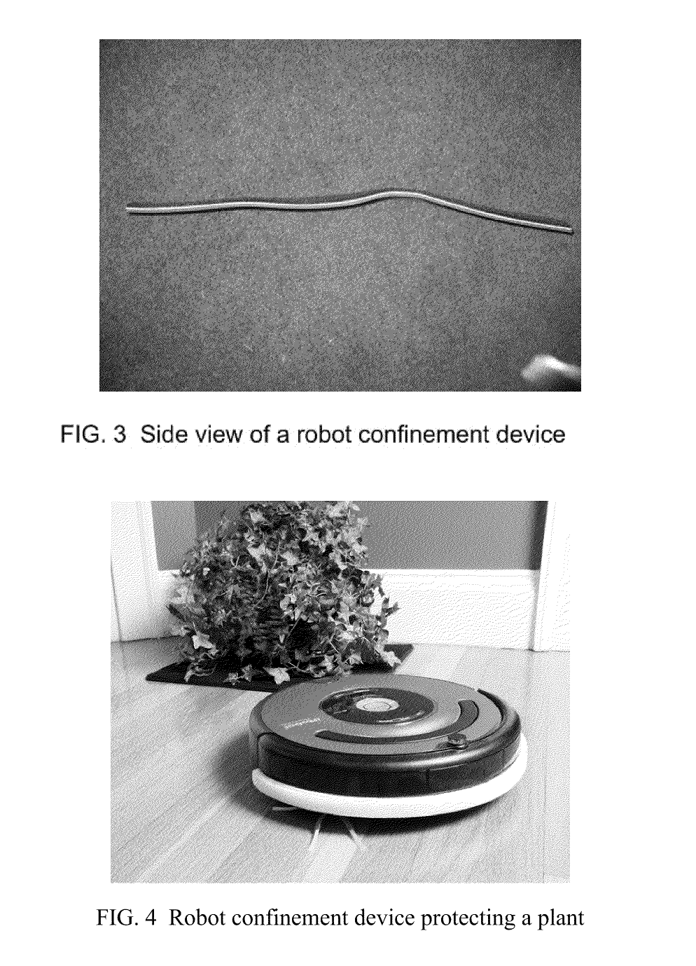

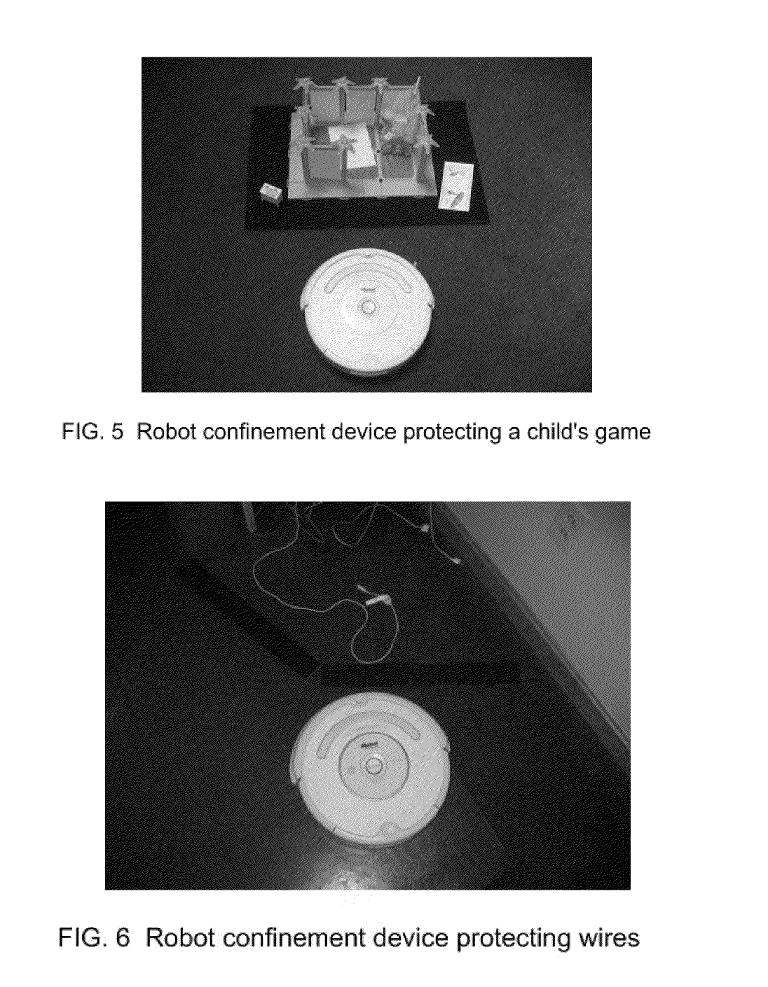

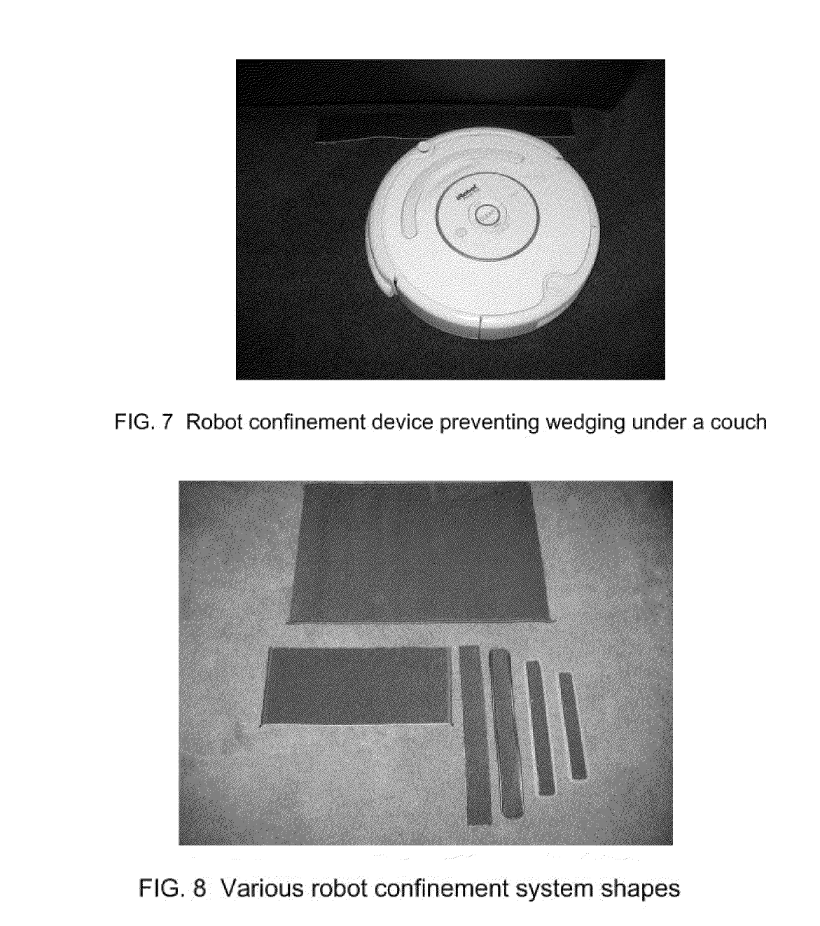

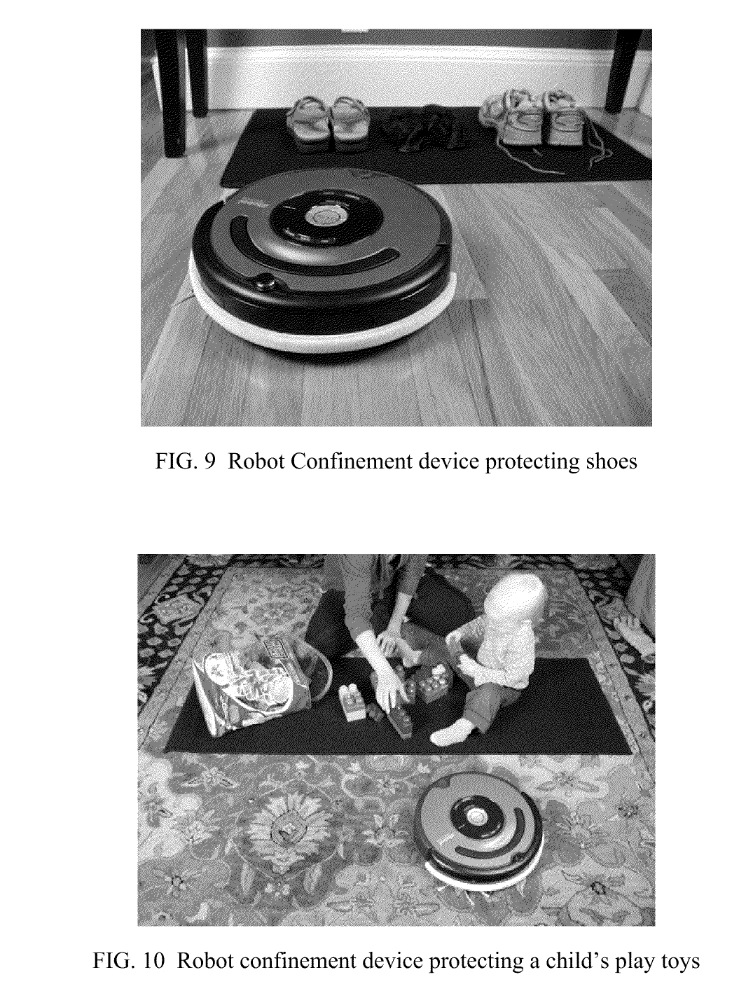

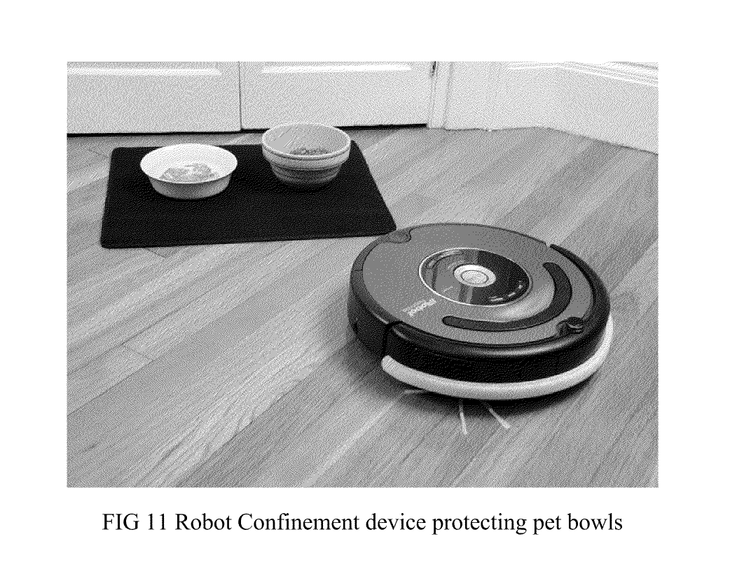

As shown in FIG. 1-11, a robot confinement device of the present invention 10 has a top surface 11, bottom surface 12 and sides surfaces 13, 14, 15 and 16 respectively. The top surface 11 is composed of a fibrous material that is black in color and is known to absorb infrared light energy.

Typical thickness of the present invention 10 is five millimeters but may be more of less depending upon the specific material used. Bottom surface 12 is composed of a material that reduces friction to allow the confinement device to remain in place and not be dislodged by the interaction of the vacuum cleaning robot making contact with the edges of the device. As shown in FIG. 8, the robot confinement device 10 may be formed in a variety of shapes such as a rectangle, square, circle, oval, octagon or any other specific shape to accommodate the area or item to be protected by the vacuum cleaning robot.

It is understood that while a certain form of the invention is illustrated, it is not to be limited to the specific form or arrangement of parts herein described and shown. It should be apparent to those skilled in the art that various changes may be made without departing from the scope of the invention and the invention is not to be considered limited to what is shown in the drawings and described in the specification. For example, while the specification describes the present invention to be used with a polypropylene material, it should be understood that other materials, such as ultra flat black coatings, Prism light structures and different fabrics be incorporated without departing from the scope of the invention. As such, although the description above contains many specificities, these should not be construed as limiting the scope of the invention but as merely providing illustrations of some of the presently preferred embodiments of this invention.

I claim:

1. A system for controlling the movement of a mobile electronic device comprising:
a light source capable of emitting light energy, wherein said light energy emanates from said mobile electronic device;
a light energy receiver, wherein said light energy receiver is capable of receiving said light energy;
a light energy inhibitor, wherein said light energy inhibitor interacts with said light energy;
a set of instructions, wherein said set of instructions may be at least in part affected by the receiving of said light energy by said light energy receiver; and a control unit, wherein said control unit may utilize said set of instructions and wherein said control unit may at least in part control the movement of said mobile electronic device.

2. The system of claim 1, wherein said light energy comprises a light direction and wherein said light direction corresponds with said movement of said mobile electronic device.

3. The system of claim 2, wherein said light energy may be emanated a first distance and wherein said first distance is ahead of the mobile electronic device relative to said movement.

4. The system of claim 3, wherein said light inhibitor further comprises at least one inhibitor strip, and wherein said inhibitor strip inhibits the reflection of light energy.

5. The system of claim 4 where said light energy is emanated and received is used as a cliff or stair detection system.

6. The system of claim 4, wherein said inhibitor strip is substantially linear.

7. The system of claim 4, wherein said inhibitor strip is substantially non-linear.

8. The system of claim 4, wherein said light energy comprises infrared light.

9. The system of claim 4, wherein said light energy comprises visible light energy.

10. The system of claim 7, wherein the receiving of light creates a cliff detection condition.

11. The system of claim 10, wherein said cliff detection condition affects said set of instructions and wherein said set of instructions affects said control unit and wherein said control unit controls said mobile electronic device with a cliff detection control.

12. A system for controlling the movement of a mobile electronic device comprising:
a light source capable of emitting infrared light energy, wherein said light energy emanates from said mobile electronic device in a forward direction relative to said movement; a light energy receiver connected to said mobile electronic device, wherein said light energy receiver is capable of receiving said infrared light energy, and wherein the receiving of said infrared light energy may affect a set of movement instructions and wherein said light energy receiver may communicate said set of movement instructions; a light energy inhibitor strip, wherein said light energy inhibitor strip inhibits reflection of said infrared light energy; a control unit, wherein said control unit may receive the communication of said set of movement instructions from said light energy receiver and said control unit may utilize said set of movement instructions to control the movement of said mobile electronic device.

13. The system of claim 12, wherein the receiving of said infrared light energy further comprises a cliff detection condition and wherein said cliff detection condition may affect said set of movement instructions and wherein said control unit controls said mobile electronic device in response to said set of movement instructions.

14. A confinement device for mobile robots to inhibit robot operation from desired areas, said device comprising:
A material that inhibits the reflection of light energy from a light source attached to a mobile robot.

15. The confinement device of claim 14 where the light energy absorbed is infrared light.

16. The confinement device of claim 14 where the light energy absorbed is visible light.

17. The confinement device of claim 14 where the material may be cut into a rectangle.

18. The confinement device of claim 14 where the material may be cut into a square.

19. The confinement device of claim 14 where the material may be cut into a circle.
